(19) United States
(12) Patent Application Publication
(10) Pub. No.: US 2005/0021529 A1
(43) Pub. Date: Jan. 27, 2005

(54) Transaction time tracking and reporting system

(76) Inventors: Jeff Hodson, Wheaton, IL (US); Anthony Dezonno, Bloomingdale, IL (US); Mary Ellen Moser, Warrenville, IL (US)

Correspondence Address: WELSH & KATZ, LTD, 120 S RIVERSIDE PLAZA, 22ND FLOOR, CHICAGO, IL, 60606, US

(21) Appl. No.: 10/624,223

(22) Filed: Jul. 22, 2003

(51) Int. Cl. G06F 17/00

(52) U.S. Cl. 707/100

(57) ABSTRACT

A method and apparatus are provided for compiling performance reports in a contact center serving a plurality of clients through the Internet using a plurality of agents. The method includes the steps of opening a transaction file for saving information about Internet exchanges between an agent of the plurality of agents and a client of the plurality of clients and measuring indicia of activity for the Internet exchanges between the agent and client. The method further includes the steps of adding the measured indicia of activity to the transaction file and compiling a report based upon the transaction file.

### FIELD OF THE INVENTION

The field of the invention relates to contact centers and more particularly to methods of measuring activity of agents working for the contact center.

### BACKGROUND OF THE INVENTION

The use of contact centers by organizations for call delivery to its agents is generally known. Contact centers are generally understood to have evolved from call centers. A call center is a call processing system that processes calls through a public switched telephone network (PSTN). The term “contact center” is generally understood to involve calls arriving through the PSTN and also through other communication mediums (e.g., the Internet).

Contact centers are differentiated from telephone and Internet message delivery systems in general by the contact center's ability to automatically deliver calls to any one of a number of agents of the organization based upon some algorithm used by the contact center. Features such as DNIS and ANI within the PSTN may be used to determine an intended call target and an identity of the caller. Similar features may be used with regard to messages sent through the Internet.

By knowing the call target of the caller, the contact center may select an agent who is best suited to handle the subject matter of the call. Further, by knowing an identity of the caller, a host attached to the contact center may retrieve customer records that may be displayed on a terminal of the agent at the instant the call is delivered to the agent.

While contact centers have been effective in advancing the interest of the contact center user, the effectiveness of contact centers is necessarily dependent upon the quality of the agents of the contact center. In this regard, efforts to evaluate and improve the quality of agent performance is often quite labor intensive, especially where the medium of communication involves the Internet. Often the only method of evaluating the performance of an agent is for a supervisor to physically observe the agent 8 performance.

While physically observing an agent at work is effective, it is also wasteful of a supervisor's time. Accordingly, a need exists for a way of tracking an agent's efforts that is adaptable to the communication medium used by the agent.

### SUMMARY

A method and apparatus are provided for compiling performance reports in a contact center serving a plurality of clients through the Internet using a plurality of agents. The method includes the steps of opening a transaction file for saving information about Internet exchanges between an agent of the plurality of agents and a client of the plurality of clients and measuring indicia of activity for the Internet exchanges between the agent and client. The method further includes the steps of adding the measured indicia of activity to the transaction file and compiling a report based upon the transaction file.

### BRIEF DESCRIPTION OF THE DRAWINGS

FIG. 1 is a block diagram of an apparatus for compiling performance statistics in accordance with an illustrated embodiment of the invention; and

FIG. 2 is a webpage that may be used by the system of FIG. 1.

### DETAILED DESCRIPTION OF AN ILLUSTRATED EMBODIMENT

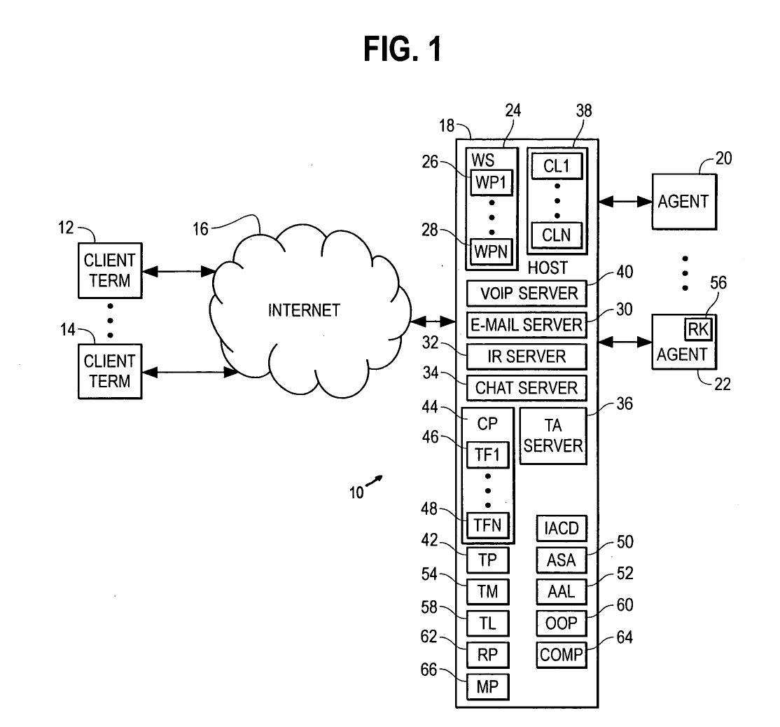

FIG. 1 is a block diagram of a transaction time tracking and reporting system 10, operating within the context of a contact center host 18 and shown generally in accordance with an illustrated embodiment of the invention. The contact center 18 may be used by any of a number of organizations (e.g., commercial, political, environmental, etc.) to promulgate the agenda of the organization through the organization's clients.

For example, the contact center 18 may be provided with a web site 24 to educate and service the needs of the organization's clients. An e-mail server 30 may be provided to exchange messages between clients and agents of the organization. Similarly, an instant messaging server 32, a chat room server 34 and Voice-over-Internet Protocol (VoIP) server 40 may be provided to exchange information with clients.

In general, the e-mail server 30, instant messaging server 32, chat room server 34 and VoIP server 40 may be provided for the routing of information between clients 12, 14 and agents 20, 22. Contacts from clients 12, 14 may be detected by the contact center 18 and assigned to an agent 20, 22. The detection of the contact and assignment to an agent 20, 22 by the contact center 18 and the routing of information between the client 12, 14 and agent 20, 22 is handled in a manner that is transparent to the client 12, 14.

An ad server 36 may be provided to download unsolicited ads to clients. The unsolicited ads may be downloaded based upon the Internet addresses from a client database 38 or from commercially available Internet address lists.

If the organization exists for commercial purposes, then the purpose of the contact center may be for sale of a product. In this case, the website 24 may contain a number of webpages 26, 28 of products offered by the organization. One or more of the webpages 26, 28 may be provided with an interactive window for forwarding questions or comments from clients 12, 14 to the host 18.

Similarly, if the organization exists for some political, social or environmental purpose, then the purpose of the contact center 18 may be to inform, educate and possibly to solicit financial support for the organization from its clients. In this case, the website 24 may contain webpages 26, 28 of political or environmental text. Interactive windows on the webpages may solicit comments or contributions.

In general, the organization may encourage the use of its website 24 by placing ads in newspapers including the Internet address (i.e., website address) of the website 24. Alternatively, the organization may contract with other website providers or search engines to supply hyperlinks to the website 24.

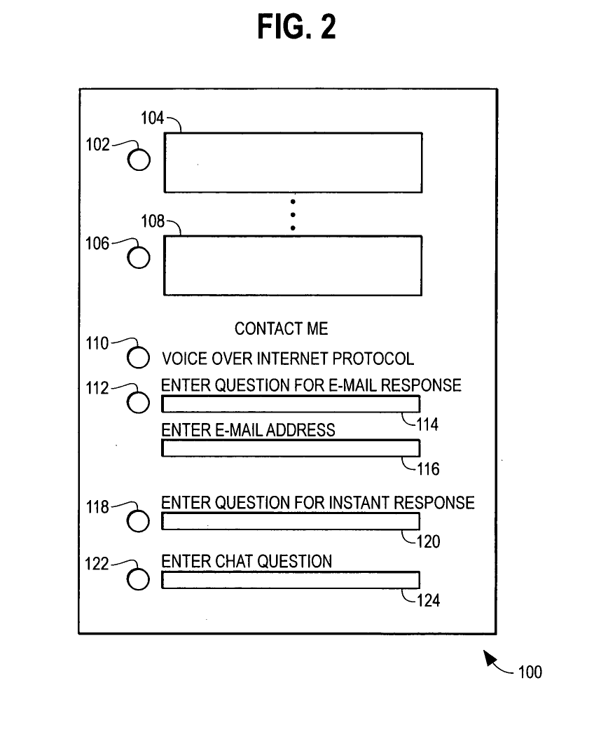

In either case, a client 12, 14 may enter the website address of the website 24 and download one or more webpages from the website 24. FIG. 2 provides an example of a webpage 100 that may be available from the website 24. As shown in FIG. 2, the webpages 10 may contain descriptive information 104, 108 of the organization as well as softkeys (i.e., hyperlinks) 104, 108 to other webpages 100. Included within the one or more webpages 100 may be one or more Internet links 110, 112, 118, 122 that, when activated, result in information being exchanged between clients 12, 14 and agents 20, 22. For example, if the client 12, 14 is in possession of the appropriate VoIP software, then the client 12, 14 may activate the VoIP softkey 110 and be placed in voice contact with an agent 20, 22.

Alternatively, the client 12, 14 may wish to e-mail a question to the organization. In this case the client 12, 14 may enter the text of the question into a interactive text window 114, his e-mail address into a second interactive window 116 and then activate the send e-mail softkey 112.

In another alternative, the client 12, 14 may wish to obtain an answer to his question more quickly. In this case the client 12, 14 may enter his question into an instant messaging text box 120 and activate an instant messaging softkey 118.

In still another alternative, the client 12, 14 may wish to determine how other people perceive the products of the organization using the contact center 18. In this case, the client 12, 14 may decide to join a chat session within a chat room provided by the host 18. In this case, the client 12, 14 may enter a question or comment in a text box 124 and activate a send button 122. Alternatively, the client 12, 14 may simply activate the button 122 to join the chat session.

Activation of one of the Internet links 110, 112, 118, 122 causes a message to be transmitted from the terminal 12, 14 of the client to the corresponding server 30, 32, 34, 40. The message may include an Internet address of the client 12, 14, an identifier of the webpage 100 from which the message originated and any information entered by the client 12, 14 through the interactive windows 114, 116, 120, 124. An agent selection application 50 processes the messages received by the respective servers 30, 32, 34, 40 for the arrival of new messages and upon detection of a new message, identifies and select an agent 20, 22 to handle the message.

The agent selection application 50 may detect new transactions by comparing an Internet identifier of each received message with a transactions list 58. The transactions list 58 contains a listing of (and identifying information from) each pending transaction. Included within each listing is an Internet identifier of the client 12, 14 and the agent 20, 22 handling the transaction. A subject matter identifier (e.g., from the “Re” line of an e-mail message) may also be included within a listing to differentiate among transactions with the same client 12, 14.

For example, a client 12, 14 may activate an Internet link 102, 106, 110, 112, 118, 122 from a first web page 100 and then activate another Internet link 102, 106, 110, 112, 118, 122 from a second web before the first transaction is completed. Since the first and second webpages 100 may be directed to different subject matter, the transactions may be assigned to different agents 20, 22.

Alternatively, the agent selection application 50 may determine from the transaction list 58 that the client 12, 14 is already being served by a previously assigned agent 20, 22. In order to preserve continuity, the agent selection application 50 may assign the new transaction to the same, previously assigned agent 20, 22 as a new transaction.

Upon selection of an agent 20, 22, the agent selection application 50 sends an identifier of the selected agent 20, 22 to the respective server 30, 32, 34, 40. An path identifier of the selected agent 20, 22 may be added to a routing list within the server 30, 32, 34, 40 as a means for transparently routing messages between the client 12, 14 and selected agent 20, 22.

To select a different agent 20, 22, the, agent selection application 50 may refer to an available agents list 52. The available agents list 52 may be maintained through a number of agent monitoring elements that contribute information to the list 52. For example, a transaction monitoring application 54 may detect the termination or completion of a transaction and (as a consequence) add an identifier of the agent 20, 22 to the agent list 52.

The transaction monitoring application 54 may detect the termination or completion of a transaction using any of a number of different methods. For example, if the organization is a merchant selling a product, then detection of the completion of a sale would be considered as an indication of the completion of the transaction. The detection of completion of a sale may be based upon receipt of a credit card number and entry of a product identifier offered by the organization. If the organization is a political or environmental organization seeking donations, then completion of a transaction may be detected by entry of a credit card number and a donation amount.

Other methods may also be used to detect completion of a transaction. For example, the passage of a predetermined amount of time without any further exchanges of information between the client 12, 14 and agent 20, 22 may be used as an indicator that the transaction is complete.

The agent 20, 22 may provide indication of completion of a transaction through activation of a release key 56. It should be noted in this regard that agents 22, 22 are typically compensated based upon productivity. In order to increase productivity, agents 20, 22 are often able to handle a number of transactions simultaneously. The agent 20, 22 may do this by activating the release key 56 each time the agent 20, 22 feels that he/she is not as busy as he/she could be. It should also be noted that if the agent 20, 22 activates the release key 56 too often and accepts too many transactions, then the agent's productivity may actually fall. The system 10 described herein provides the feedback to the agent to help the agent 20, 22 recognize and overcome such difficulties.

In general, a transaction processor 42 function to monitor the activity of each transaction. The agent selection application 50 sends a new transaction message to the transaction processor each time a new transaction is detected. The transaction monitoring application 54 sends the transaction processor 42 an end transaction message each time a transaction is completed.

The transaction processor 42 functions to identify and track interchanges between clients 12, 14 and agents 20, 22 of the organization. As each transaction begins, a transaction file 46, 48 is opened to track the time and effort expended by the agent 20, 22 in addressing the concerns of the client 12, 14. Each transaction file 46, 48 may include an Internet address of the client 12, 14, an identifier of the webpage 100 from which the message arose and an identifier of the selected agent 20, 22. As the transaction progresses, an indicia of activity of each message (i.e., transmission) may be measured by a measurement processor 66 and added to the file along with a time stamp. The time stamp may be used within a comparator 64 to determine how much time has elapsed between successive transmissions of each transaction.

Upon completion of the transaction, the file is added to a transaction database. The transaction database may be used to generate reports and statistics regarding agent performance.

As used herein, measuring indicia of activity means measuring the effort expended by an agent in addressing the concerns of the client. Measuring the effort may mean measuring the number of messages (e.g., e-mail messages, instant messages, chat session messages, VoIP messages, etc.) required to close a sale or to satisfy the client with regard to a particular client concern. Measuring the effort may also mean extrapolating to determine the amount of time required by the agent to prepare the e-mail, instant messages or chat session messages from the number of words or the content of an e-mail composed by the agent. Similarly, voice recognition from a voice recognition application coupled to the VoIP exchange between the client 12, 14 and agent 20, 22 may be used to determine the word content (i.e., the effort) involved in a VoIP exchange.

The generation of the transaction records under the illustrated embodiments differs from prior art efforts in a number of regards. For example, prior art efforts were typically directed to measuring a time of use of a transaction channel. This was particularly useful in the case of telephone and video conferencing because detection of channel use is much easier than detecting communication content transmitted through the channel. In effect, prior art efforts may be referred to as synchronous because instead of measuring communication content, the prior art systems measured the synchronous (i.e., concurrent) use of the channel that transmitted the communication content.

In contrast to the processes of the prior art, the processes described herein operate upon what can be characterized as asynchronous transactions. Asynchronous transactions refer to data transactions that are for the most part intermittent and in which the data is created first and then transmitted afterwards. Asynchronous transactions pass through the Internet and may be based upon any of a number of different technologies (e.g., e-mail, chat, web access, other text based media, etc.).

Asynchronous transactions are different from prior art because of the nature of the transaction. For example, a transaction may begin with an initial e-mail. After the initial e-mail, other e-mails may be exchanged over a period of minutes, hours or days before the transaction is completed. Thus it is difficult to determine how long the transaction actually required for completion. Similarly, instant messaging and whiteboard (while being more pseudo-asynchronous in nature) are still asynchronous, but are typically completed within a relatively short period of time (but not necessarily so).

The method of creating transaction files essentially assigns a metric (indicia of activity) that may be used to determine the total length of time that a transaction takes from inception to completion (or abandonment), for both asynchronous and pseudo-asynchronous transactions (both types hereinafter referred to as “asynchronous transactions”). Thus, the indicia of activity of each contact can be incorporated into a transaction file for each transaction, thereby allowing asynchronous transactions to be incorporated into various efficiency reports. The results of having this type of information available from asynchronous transactions may be significant.

For example, it may be theorized that 70% of all data transactions fail to result in a successful outcome (e.g., closing of a sale in a commercial setting) if the total time of the transaction exceeds a predetermined time period, or if a certain number of time gaps occur in the transaction. Reports that measure such parameters as time gaps in responses may be used as a tool to motivate an agent to offer quicker responses so that a client does not become frustrated or annoyed with the time delay, and hence decide to abandon the transaction rather than to complete it.

The method essentially calculates a duration of the various non-contiguous data transmissions that comprise a single transaction. First, a transmission type is assigned to each transmission, such as synchronous, asynchronous and pseudo-synchronous. It should be understood that while the method described herein is primarily directed to the asynchronous and pseudo-asynchronous types of transmission, it could also be applied to synchronous transmission through measurement of the appropriate indicia of activity that is not based upon a duration of channel occupancy.

Once a transmission type is determined, each continuing message may be tagged as belonging to a particular transaction. As discussed above, the Internet addresses of the client 12, 14 and agent 20, 22 may provide a first level of transaction identification. In the case of e-mail, a subject matter on a “Re” line may provide a second, higher level of transaction identification that may be used to differentiate among transactions between the same client 12, 14 and agent 20, 22. Alternatively, a word content of each exchange may be used to differentiate among transaction, such as where the client 12, 14 initiates the contact on a first subject and upon completion of the first transaction immediately changes the subject to address a second subject.

Once each transmission is tagged as belonging to a particular transaction, a duration time may be calculated and assigned to the effort associated with each transmission as one form of the indicia of activity. Of course, this is different than assigning a duration time to a switched circuit call through the public switch telephone network since only the start and end times of the switched circuit call would be important. With text/data (asynchronous) transmission, however, the task is more difficult, as the duration of the actual transmission is meaningless, because only a few milliseconds are required to transmit a lengthy e-mail.

One way to assign or determine a duration value of the effort is based on the character length of the transmission, for example, the number of words. Empirical data can be used to determine the length of time required to compose an e-mail (or letter) of a certain length of course, this may vary by subject matter, which could lead to specific adjustments of this formula depending upon the department or subject matter specialty. Additionally, correction factors may be included in the calculation to account for proportionality. This is because a 100 word e-mail may not take ten times as long to compose as a 10-word e-mail other methods to calculate an “equivalent” time of effort may be used. For example, a calculation may be performed to determine how long that data transmission would have required had it been spoken, taking into account the typing time and perhaps additional “thinking” time usually associated with written words compared to spoken words.

After each transmission of the transaction is measured with respect to its duration of effort, it can be included in a statistical report. The total calculated duration of the completed transaction may then be calculated by simple addition and displayed. Alternatively, even a non-completed transaction may be displayed in the report as on “on-going” transaction. Of course, its duration would continue to increase in real time until completed or abandoned.

In addition to collection of data associated with the effort required to complete each transaction, an organizational objectives application 60 may collect information related to contribution of each agent 20, 22 to the objectives of the organization. For example, if the organization is a political or environmental organization seeking donations, then the objectives processor 60 may detect and compile the donations received by each agent. Detection of a donation may be determined by entry of a dollar value and a credit card number.

If the organization is a merchant selling products, then the objectives processor 60 may detect and compile the sales may by each agent. Detection of a sale may be determined by entry of a product identifier and entry of a customer account number or a credit card number.

Further, the outcome of a transaction can be added to the transaction files 46, 48. In the case of a merchant, the entry of sales information into the transaction file 46 may be used as a method of differentiating between successful transactions and abandoned transactions. It may also be used to collect and reveal statistics regarding the likelihood of success versus the number of exchanges during a transaction.

Once the transaction files are created, the data may be sorted and correlated by a report processor 62 according to any of a number of factors. For example, if the organization is a merchant and the objective of the organization is sale of product described on the webpages, then the transaction records of the agents 20, 22 providing the greatest revenue may be analyzed for characteristics suggestive of the basis for the revenue. For example, the average time between messages for transactions handled by each agent may be provided as an objective measure of customer service. Alternatively, the determination of effort associated with each transaction may be determined for each agent and provided as an objective comparison between successful and less successful agents 20, 22.

In organizations such as political or environmental organizations where the organization objective is public awareness and is not easily measured, then the system 10 may be used as a source of information for compensating agents. In this case the measured effort coupled with the objective measurement of customer service may be used within an incentive plan to compensate agents 20, 22 for their work.

Thus, using this method, the supervisor can track the duration of each data transaction and can correlate completion and abandonment statistics upon the effective duration of the data transaction. Also, the number of non-contiguous parts comprising the data transmission can be viewed. This may, for example alert the supervisor that data transactions that require more than 10 e-mails have a 90% non-completion rate. Also, knowing the effective length or duration of each data transmission, the supervisor can more accurately determine the agent staffing needs.

A specific embodiment of a method and apparatus for compiling performance reports has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of compiling performance reports in a contact center serving a plurality of clients through the Internet using a plurality of agents, such method comprising the steps of:
opening a transaction file for saving information about Internet exchanges between an agent of the plurality of agents and a client of the plurality of clients;
measuring indicia of activity for the Internet exchanges between the agent and client;
adding the measured indicia of activity to the transaction file; and
compiling a report based upon the transaction file.

2. The method of compiling performance reports as in claim 1 wherein the step of opening the transaction file further comprises detecting an initial contact between the agent and the client.

3. The method of compiling performance reports as in claim 2 wherein the step of detecting the initial contact between the agent and the client further comprises searching a prior contact list of the agent to identify prior contacts involving the client.

4. The method of compiling performance reports as in claim 1 wherein the step of measuring the indicia of activity further comprises counting a number of exchanges between the agent and the client.

5. The method of compiling performance reports as in claim 4 wherein the exchanges further comprise e-mail.

6. The method of compiling performance reports as in claim 4 wherein the exchanges further comprise instant messaging.

7. The method of compiling performance reports as in claim 4 wherein the exchanges further comprise chat sessions.

8. The method of compiling performance reports as in claim 1 further comprising segregating exchanges between the agent and client from other exchanges between other agents of the plurality of agents and other clients of the plurality of clients.

9. The method of compiling performance reports as in claim 8 wherein the step of segregating exchanges between the agent and client from other exchanges between other agents of the plurality of agents and other clients of the plurality of clients further comprises correlating an identifier of the agent and client with the transaction file.

10. The method of compiling performance reports as in claim 9 wherein the step of correlating an identifier of the agent and client with the transaction file further comprises matching e-mail addresses of the agent and client to e-mail addresses within the transaction file.

11. The method of compiling performance reports as in claim 1 further comprising segregating exchanges between the agent and client from other exchanges between the agent agent and the client.

12. The method of compiling performance reports as in claim 11 wherein, the step of segregating exchanges, between the agent and client from other exchanges between the agent and client further comprises correlating a subject matter identifier field of the exchanges with a subject matter identifier of the transaction file.

13. An apparatus for compiling performance reports in a contact center serving a plurality of clients through the Internet using a plurality of agents, such apparatus comprising:
means for opening a transaction file for saving information about Internet exchanges between an agent of the plurality of agents and a client of the plurality of clients;
means for measuring indicia of activity for the Internet exchanges between the agent and client;
means for adding the measured indicia of activity to the transaction file; and
means for compiling a report based upon the transaction file.

14. The apparatus for compiling performance reports as in claim 13 wherein the means for opening the transaction file further comprises means for detecting an initial contact between the agent and the client.

15. The apparatus for compiling performance reports as in claim 14 wherein the means for detecting the initial contact between the agent and the client further comprises means for searching a prior contact list of the agent to identify prior contacts involving the client.

16. The apparatus for compiling performance reports as in claim 13 wherein the means for measuring the indicia of activity further comprises means for counting a number of exchanges between the agent and the client.

17. The apparatus for compiling performance reports as in claim 16 wherein the exchanges further comprise e-mail.

18. The apparatus for compiling performance reports as in claim 16 wherein the exchanges further comprise instant messaging.

19. The apparatus for compiling performance reports as in claim 16 wherein the exchanges further comprise chat sessions.

20. The apparatus for compiling performance reports as in claim 13 further comprising means for segregating exchanges between the agent and client from other exchanges between other agents of the plurality of agents and other clients of the plurality of clients.

21. The apparatus for compiling performance reports as in claim 20 wherein the means for segregating exchanges between the agent and client from other exchanges between other agents of the plurality of agents and other clients of the plurality of clients further comprises means for correlating an identifier of the agent and client with the transaction file.

22. The apparatus for compiling performance reports as in claim 21 wherein the means for correlating an identifier of the agent and client with the transaction file further comprises means for matching e-mail addresses of the agent and client to e-mail addresses within the transaction file.

23. The apparatus for compiling performance reports as in claim 13 further comprising means for segregating exchanges between the agent and client from other exchanges between the agent agent and the client.

24. The apparatus for compiling performance reports as in claim 23 wherein the means for segregating exchanges between the agent and client from other exchanges between the agent and client further comprises means for correlating a subject matter identifier field of the exchanges with a subject matter identifier of the transaction file.

25. An apparatus for compiling performance reports in a contact center serving a plurality of clients through the Internet using a plurality of agents, such apparatus comprising:
a transaction processor adapted to open a transaction file for saving information about Internet exchanges between an agent of the plurality of agents and a client of the plurality of clients;
a measurement processor adapted to measure indicia of activity for the Internet exchanges between the agent and client;
a transaction file for collecting the measured indicia of activity; and
a reports processor adapted to compile a report based upon the transaction file.

26. The apparatus for compiling performance reports as in claim 25 further comprising an agent selection processor adapted to detect an initial contact between the agent and the client.

27. The apparatus for compiling performance reports as in claim 26 wherein the agent selection processor further comprises a prior contact list adapted for identifying prior contacts involving the client.

28. The apparatus for compiling performance reports as in claim 25 wherein the exchanges further comprise e-mail.

29. The apparatus for compiling performance reports as in claim 25 wherein the exchanges further comprise instant messaging.

30. The apparatus for compiling performance reports as in claim 25 wherein the exchanges further comprise chat sessions.
